(19) United States
(12) Patent Application Publication
(10) Pub. No.: US 2012/0276262 A1
(43) Pub. Date: Nov. 1, 2012

(54) METHOD AND APPARATUS FOR HANDLING STERILIZED FOOD PRODUCT

(75) Inventors: Gregory W. SCHRADER, Lakeland, FL (US); Paul P. BROCKER, Lakeland, FL (US)

(73) Assignee: JOHN BEAN TECHNOLOGIES CORPORATION, Chicago, IL (US)

(21) Appl. No.: 13/465,711

(22) Filed: May 7, 2012

Related U.S. Application Data
(63) Continuation-in-part of application No. 12/941,135, filed on Nov. 8, 2010.

(51) Int. Cl. A23B 7/005

(52) U.S. Cl. 426/389

(57) ABSTRACT

A method is for handling a sterilized food product including sterilizing an intermodal container comprising a rigid shell with opposed closed ends and a discharge port in one of the closed end, and aseptically filling the intermodal container with the sterilized food product. The method further includes transporting the filled intermodal container while maintaining the sterilized food product in aseptic conditions. In addition, the method may include, at an emptying site, moving the intermodal container to an incline angle of at least 8 degrees from horizontal, and emptying the sterilized food product from the discharge port.

### RELATED APPLICATION

The present application is a continuation-in-part of U.S. application Ser. No. 12/941,135, filed Nov. 8, 2010, the entire contents of which are incorporated herein by reference.

### FIELD OF THE INVENTION

The present invention relates to the field of food science, and, more particularly, to the area of aseptically handling food products.

### BACKGROUND OF THE INVENTION

In the field of food processing, it is common to process food at one location and transport bulk quantities to another location for further processing or final packaging. Various methods have been developed for containing and transporting food products. For example, fruit juice or milk is often processed at one facility and sent to another facility for final packaging. The two facilities may be located in close proximity to each other or may be in different countries. Because food products are susceptible to degradation due to microbial spoilage, various processing methods are used to retard or prevent the growth of microorganisms during this transportation and storage. These include sterilizing the food product inside a container, hot-filling a clean container, or putting the sterile food product into a sterile container. Other methods include freezing, refrigeration or the use of preservatives.

Disadvantages of sterilizing inside a container include the expense of such a container and the food product degradation due to the amount of heat required. Also, because of the need to sterilize the cold point of the food product, this type of processing is common for final packaging, but not typically done for bulk products. Bulk food product is food product in a quantity that is much larger than that in the final retail or food service package. Bulk food product is typically more than 50 gallons, for example. Likewise, hot filling is typically used for final packaging, but not for bulk products.

In contrast, freezing is a typical method for processing bulk products for transportation. For example, pasteurized fruit juices are often filled into 55 gallon drums, often with a drum liner, and then frozen prior to shipping. Disadvantages of freezing include the energy required for freezing, the energy required to keep the product frozen during the transportation and storage cycle, and the cost of the drums. Additional disadvantages include the potential physical and chemical changes of the product due to freezing. For example, when citrus pulp cells are frozen, the cell walls are disrupted. Upon thawing, the pulp cells have different physical characteristics than pulp cells that have not been frozen.

There are many disadvantages to the use of chemical preservatives for certain food products. These include consumer perception and changes in flavor. In many food products, the use of preservatives is not allowed under standard of identity or by law.

For certain food products, the method of putting a sterile food product into a sterile container has many advantages over the above mentioned processes. This method is typically referred to as aseptic processing. In aseptic processing, a food product is pasteurized to a point where it is considered commercially sterile. In such a state, there is a very low probability of the presence or growth of microorganisms. The sterilized food product is then placed into a sterile container in such as way as to avoid the introduction of microorganisms. Aseptic processing can be used to put sterilized food product into the final consumer container (for example, shelf stable milk or juice) or can be used to store and transport bulk food products in an aseptic state. For example, juices and tomato products are often pasteurized and aseptically filled into 300 gallon bags for storage and transportation to other food processing facilities. Likewise, juices may be pasteurized and aseptically filled into large permanent bulk containers (currently up to two million gallons) for storage prior to blending and packaging.

The most common form of aseptic food product transportation includes the use of 300 gallon bags as mentioned above. Such a bag is filled within a disposable or re-usable container such as a wooden box, or re-usable plastic container, and the bag is sealed with a cap after filling. The wooden or plastic container supports the bag and allows for the boxes to be stacked during transportation. Citrus pulp is currently aseptically filled into such “bag-in-the-box” containers. While widely used, the disadvantages of this method include the cost of the bags and the boxes. When shipped overseas, the return of empty boxes for further use incurs additional cost. An additional disadvantage of such a system is that the bags cannot be aseptically unloaded. At the point of use, the bags are cut open and the product is dumped or pumped out of the bags. It is therefore necessary to further pasteurize the product prior to final packaging.

Another method of aseptic transportation involves the use of aseptic tankers or rail cars and over-the-road containers. The rail cars typically had cone shaped hoppers on the bottom. This method was used by Bishopric Products Co. (formerly of Cincinnati, Ohio) to transport tomato product (Food Technology, July 1976). Tankers were sterilized through the use of steam or chemical sterilant (iodophor, for example) and then filled with sterile product. Such food product was kept under pressure with sterile gas during transportation and was successfully transported in an aseptic state from one site to another.

For example, U.S. Pat. No. 3,209,675 discloses an apparatus for the aseptic transportation of perishable liquids. The apparatus described is a transportable container, sterilized by a chemical sterilant (peracetic acid) and kept pressurized during transportation by the use of a cylinder of inert gas. U.S. Pat. Nos. 6,030,580 and 6,277,328 also disclose a method of aseptically transporting bulk food product in a transportable container. The use of aseptic tankers or rail cars as described in these patents overcomes the cost of bags and boxes and provides for a more economical method of transporting aseptic product.

Hawaii Intermodal Tank Transport LLC, of Palmetto, Fla., supplies aseptic intermodal containers for the aseptic transportation of food product. Such intermodal containers use the same principles as mentioned above for aseptic tankers and rail cars, but provide the additional advantage of being configurable to be transportable by truck, rail or ship. Juice is currently being aseptically transported in such intermodal containers.

With reference to FIG. 1, such an intermodal container 30 includes a cylindrically shaped rigid shell 31 that may be approximately 20 feet long, and that may hold approximately 24,000 liters. The shell includes rear and front closed ends 32a, 32b in the form of shallow domes. A discharge port is positioned behind a rear panel access door 33 at the bottom of the rear closed end 32a. The intermodal container 30 also includes a pair of rear and front rectangular support frame assemblies 35a, 35b that support the rigid shell and permit stacking of the containers, such as for transportation via ship, or when in a storage area, for example. The container 30 may also include inwardly extending corner support arms, not shown, that extend inwardly from the corners of the respective support frame assemblies 35a, 35b and attach to the rigid shell 31. The intermodal container 30 also illustratively includes a ladder 36 carried by the rear support frame assembly 35a, and a horizontal walking platform 37 to facilitate access to the manway and other ports on the top of the rigid shell 31. The intermodal container 30 in some configurations may include an insulation layer associated with the rigid shell 31. In addition, a portable refrigeration unit may be provided to keep the contents cold, and one or more temperature and/or pressure sensors may be provided to monitor the contents.

While providing a safe and economical method to aseptically transport liquid food products, the use of aseptic tankers, rail cars and intermodal containers does not lend itself to the aseptic transportation of high viscosity products, such as, for example, tomato paste, high viscosity fruit purees or citrus pulp. High viscosity food products may be considered as food products that do not readily flow by gravity. These products, if placed into a typical tank with a free-draining bottom will not flow out of the tank or will flow at such a slow speed that gravity draining is impractical. Such products may be pumpable with the correct pump selection and can thus be pumped into an aseptic container. However, because these products do not readily flow by gravity, it is not easy to remove such high viscosity food products from such a container.

An intermodal container typically also includes an aseptic filling/discharge valve that is used to both fill and discharge the food product. When switching from one container to another, a hose is disconnected from one container and connected to another. Since the hose is disconnected and exposed to the atmosphere, the aseptic condition is lost. Therefore, the hose is re-sterilized when connected to the next container. In addition, an outer chamber of the filling valve is also sterilized before passing sterile food product through the valve. This sterilization process may require a substantial amount of time between containers. Since it is a manually intensive process, it may be susceptible to user-error which could result in product contamination. Such aseptic filling of tanks and containers is disclosed, for example, in U.S. Pat. Nos. 3,951,184 and 4,047,547, the entire disclosures of which are incorporated herein by reference in their entireties.

U.S. Pat. No. 3,209,675, for example, discloses an apparatus for the aseptic transportation of perishable liquids. The apparatus described is a transportable container, sterilized by a chemical sterilant (peracetic acid) and kept pressurized during transportation by use of a cylinder of inert gas. U.S. Pat. Nos. 6,030,580 and 6,277,328 both describe the aseptic transportation of food product with a chemical sterilant.

Juice and other liquid food products are currently being aseptically transported in intermodal containers by Hawaii Intermodal Tank Transport. The intermodal containers can be transported by truck, rail or ship, and they are filled and discharged through a single valve located on the low point of the tank. Re-sterilization of the filling line is required between each container.

### SUMMARY OF THE INVENTION

In view of the foregoing background, an object of the present invention is to provide a method for the efficient aseptic handling of food products, such as food products having a high viscosity.

These and other objects, features and advantages in accordance with the invention are provided by a method for handling a sterilized food product including sterilizing an intermodal container comprising a rigid shell with opposed closed ends and a discharge port in one of the closed ends. The method may also include aseptically filling the intermodal container with the sterilized food product. The method further includes transporting the filled intermodal container while maintaining the sterilized food product in aseptic conditions. At an emptying site, the method includes moving the intermodal container to an incline angle of at least 8 degrees from horizontal, and emptying the sterilized food product from the discharge port.

Accordingly, a bulk quantity of sterilized food product may be efficiently transported and emptied from the intermodal container using the advantage of gravity-based emptying. Of course, the method is particularly advantageous for such emptying when the sterilized food product comprises a viscous sterilized food product, such as citrus pulp, for example, or other food product having an absolute viscosity of greater than 500 centipoise.

The rigid shell may have an elongate shape, and the intermodal container may comprise forward and rearward support frame assemblies supporting the rigid shell. The opposing closed ends may comprise forward and rearward closed ends, and the discharge port may be in the rearward closed end. Transporting may comprise transporting the filled intermodal container via a transport vehicle, such as by rail, truck or ship, for example.

In some embodiments, moving the intermodal container may comprise pushing upwardly on the forward support frame assembly to rotate the intermodal container. For example, pushing upwardly may comprise advancing the transport vehicle up an inclined ramp. Alternatively, pushing upwardly may comprise raising a front of the transport vehicle relative to a back of the transport vehicle.

The method may also include supplying a sterile gas to maintain a positive pressure within the intermodal container at least during emptying. In addition, a pump coupled to the discharge port may be used during emptying.

The incline angle may be at least 18 degrees from horizontal in some embodiments, and at least 30 degrees from horizontal in other embodiments. The intermodal container may have a capacity greater than 10,000 liters, and may have the discharge port in a lower portion of the closed end of the intermodal container.

The method may include maintaining at least one of a desired pressure and desired temperature within the intermodal container during transporting. Also, the method may comprise at least one of recording and wirelessly transmitting at least one of the desired pressure and desired temperature. The sterilizing may comprise sterilizing using at least one of steam and a chemical sterilant.

### BRIEF DESCRIPTION OF THE DRAWINGS

FIG. 1 is a perspective view of an intermodal container as in the prior art.

FIG. 2 is a flowchart of a method of handling a sterile food product in accordance with the invention.

FIGS. 3A and 3B are schematic side elevational views illustrating rotating and emptying, respectively, in accordance with the method of FIG. 2.

FIG. 4 is a schematic view of a portion of another embodiment of an intermodal container in accordance with the present invention.

FIG. 5 is a greatly enlarged portion of the rigid shell of the intermodal container as shown in FIG. 4.

FIG. 6 is a flowchart for another method of handling a sterile food product in accordance with the invention.

FIG. 7 is a schematic diagram of an aseptic filling station and intermodal container for use in accordance with the method of FIG. 6.

FIG. 8 is a more detailed schematic side view of a portion of another embodiment of an aseptic filling station and intermodal container in accordance with the present invention.

FIG. 9 is a more detailed schematic side view of the intermodal container as shown in FIG. 8.

FIG. 10 is a cross-sectional view of a membrane-type aseptic fitment for use on the intermodal container in accordance with the present invention.

FIG. 11 is a cross-sectional view of another embodiment of the membrane-type aseptic fitment as shown in FIG. 10.

FIG. 12A is a cross-sectional view of yet another embodiment of the membrane-type aseptic fitment as shown in FIG. 10.

FIG. 12B is a plan view of the shoulder portions of the membrane-type aseptic fitment as shown in FIG. 12A.

FIG. 13 is a cross-sectional view of the membrane-type aseptic fitment as shown in FIG. 10 mounted on an intermodal container.

FIG. 14 is a cross-sectional view of the membrane-type aseptic fitment as shown in FIG. 10 after rupturing of the membrane.

FIG. 15 is a cross-sectional view of a cap-type aseptic fitment for use on the intermodal container in accordance with the present invention.

FIG. 16 is a cross-sectional view of another embodiment of the cap-type aseptic fitment as shown in FIG. 15.

FIG. 17A is a cross-sectional view of yet another embodiment of the cap-type aseptic fitment as shown in FIG. 15.

FIG. 17B is a plan view of the shoulder portions of the cap-type aseptic fitment as shown in FIG. 17A.

FIG. 18 is a cross-sectional view of the cap-type aseptic fitment as shown in FIG. 15 mounted on an intermodal container.

FIG. 19 is a side elevational view of the cap-type aseptic fitment as shown in FIG. 15 positioned within a sterile bag.

FIG. 20 is a side elevational view, partially in section, of the membrane-type aseptic fitment as shown in FIG. 10 and installed on an intermodal container.

FIG. 21 is a flowchart of another method of handling a sterile food product in accordance with the invention.

FIG. 22 is a schematic side elevational view of a system for rotating and emptying in accordance with the method of FIG. 21.

FIG. 23 is schematic side elevational view of another system for rotating and emptying in accordance with the method of FIG. 21.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notation are used to indicate similar elements in alternative embodiments.

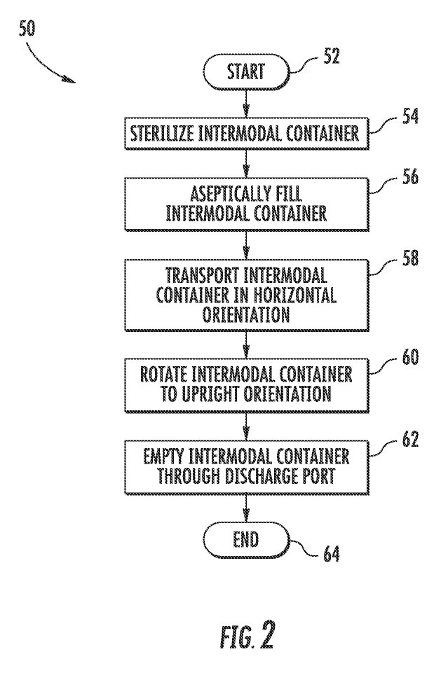

Referring initially to the flowchart 50 of FIG. 2, a method for handling a sterilized food product is now described. After the start (Block 52), the method includes sterilizing an intermodal container (Block 54) comprising a rigid shell having an elongate shape with opposed closed ends and a discharge port in one of the closed ends. The sterilizing may comprise sterilizing the interior of the intermodal container using at least one of steam and a chemical sterilant.

In some embodiments, the intermodal container may be of the conventional type described above and offered by Hawaii Intermodal; however, in other embodiments, the intermodal container may be of the advantageous types as described below. The intermodal container may include at least one support frame assembly supporting the rigid shell and configured to permit rotation between a generally horizontal orientation and a generally upright orientation.

The generally upright orientation may be at an angle greater than 40° from horizontal, and the generally horizontal orientation may be less than 40° from horizontal. Of course, oftentimes it may be that the intermodal container is transported in a nearly exact horizontal orientation, and that the intermodal container is emptied in a fully upright or vertical orientation as will be appreciated by those skilled in the art.

The method also includes aseptically filling the intermodal container with the sterilized food product at Block 56. At Block 58 the method also includes transporting the filled intermodal container in the generally horizontal orientation via at least one of rail, truck, and ship while maintaining the sterilized food product in aseptic conditions. At the desired emptying destination, the method includes at Block 60 rotating the intermodal container to the generally upright orientation, and emptying the sterilized food product from the discharge port (Block 62) before stopping at Block 64. The method advantageously permits a bulk quantity of sterilized food product to be efficiently transported and emptied from the intermodal container using the advantage of gravity-based emptying. The emptying may also be carried out aseptically as will be appreciated by those skilled in the art.

The method is particularly useful for such emptying when the sterilized food product comprises a viscous sterilized food product, such as citrus pulp, for example, or other food product having an absolute viscosity of greater than 500 centipoise. Attempting to pump such a viscous food product in a conventional fashion from a conventional intermodal container in the horizontal orientation may take a relatively long time and/or leave an undesirably large amount of food product within the container as will be appreciated by those skilled in the art.

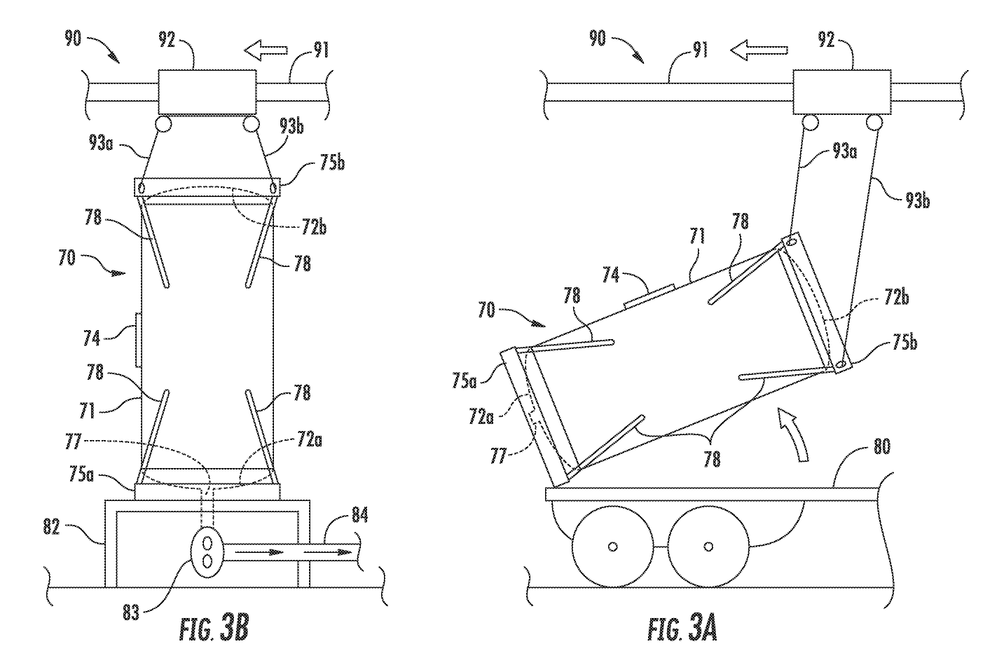

With additional reference to FIGS. 3A and 3B, the rotating and emptying are further described. In particular, rotating is illustratively achieved by engaging the forward support frame assembly 75b with a lifting device in the form of an overhead crane 90 including an overhead horizontal support member 91, a movable crane trolley 92 carried by the support member, and lifting cables 93a, 93b extending from the crane trolley. The intermodal container 70 may include suitable engaging fittings, such as eyelets, or other openings to facilitate the temporary attachment of the lifting cables 93a, 93b. In some embodiments, the suitable engaging fittings, not shown, may be positioned on the rigid shell 71. Of course in other embodiments, the intermodal container 70 may be grasped and manipulated using other types of moving equipment.

The intermodal container 70 is illustratively lifted from the truck bed 80 (FIG. 3A), rotated, and the rear support frame assembly 75a is placed upon an emptying stand 82 (FIG. 3B). A pump 83 is coupled in fluid communication with the discharge port 77 typically via an aseptic valve, not shown, secured to the rigid shell 71 at the discharge port. In other embodiments, gravity feeding alone may be sufficient so that the pump 83 is not needed, or the pump need not be placed immediately below the rigid shell 71.

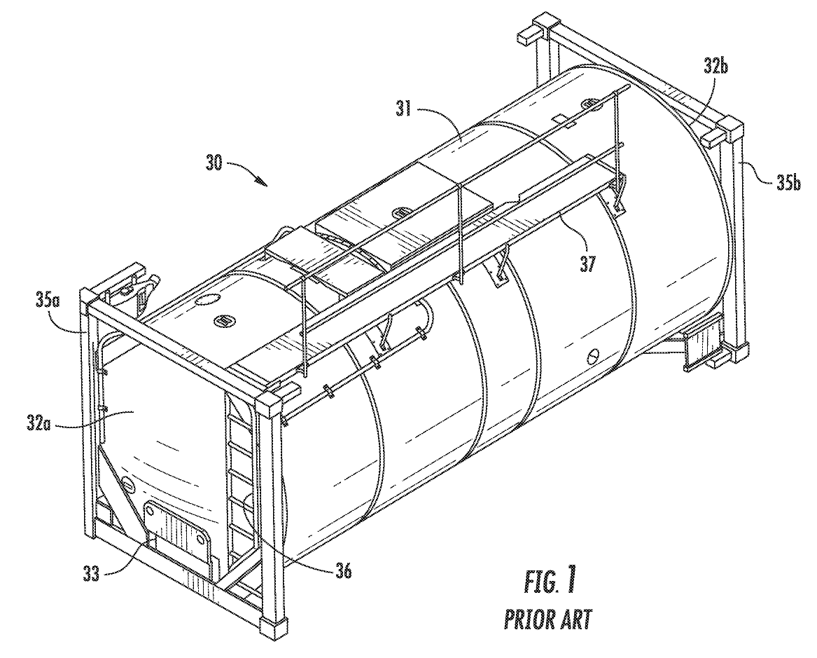

In typical embodiments, the intermodal container may have a capacity greater than 10,000 liters, and typically about 24,000 liters, for example. Unlike a conventional intermodal container 30 as shown in FIG. 1 wherein the discharge port is at the lower periphery of the rear closed end, the discharge port 77 of the intermodal container 70 is illustratively positioned in a medial portion of the rear closed end 72a of the rigid shell 71. The intermodal container 70 also illustratively includes a manway cover 74 and the rigid shell 71 includes a domed shaped forward or front closed end 72b. Corner support struts 78 also illustratively extend from the respective support frame assemblies 75a, 75b to corresponding attachment areas along the outside of the rigid shell 71.

As will be appreciated by those skilled in the art, the method may also include supplying a sterile gas to maintain a positive pressure within the intermodal container 70, such as during transporting or storage, and also during emptying, as the positive pressure helps maintain the aseptic conditions for the sterile food product and may help in emptying the rigid shell 71. Additionally, the method may further include maintaining at least one of a desired pressure and desired temperature within the intermodal container 70 during transporting. The desired pressure and/or desired temperature may be recorded or wirelessly transmitted.

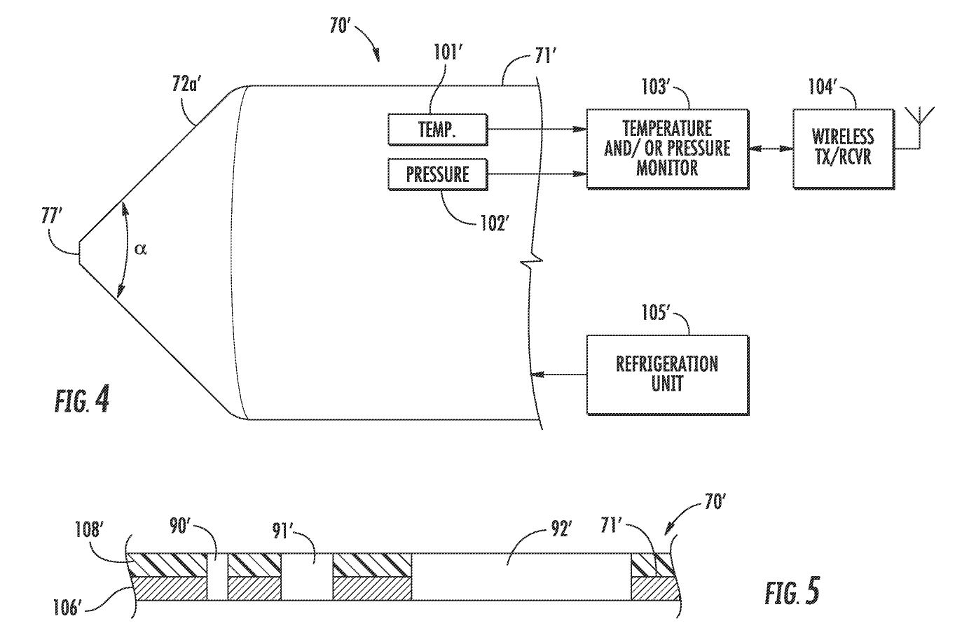

Referring now additionally to FIGS. 4 and 5, another embodiment of an intermodal container 70′ is now described. In this embodiment, the rear closed end 72a′ of the rigid shell 71′, having the discharge port therein 77′, has a conical shape, and the discharge port is positioned at the apex of the conical shape. The conical shape may define an included angle α greater than 45° and less than 90°, for example. In other embodiments, the discharge port 77′ may be offset from an axis of the cylindrical shell 71′. In these offset embodiments, it might not be necessary to rotate the intermodal container to the full upright position as will be appreciated by those skilled in the art.

The intermodal container 70′ also illustratively includes a temperature sensor 101′ and a pressure sensor 102′ coupled to or positioned within the rigid shell 71′. A data recorder in the form of a temperature and/or pressure monitor 103′ is coupled to the sensors 101′, 102′. This monitor 103′ can include electronic circuitry carried by the rigid shell 71′ or carried by one of the support frame assemblies, for example. The monitor 103′ can be manually read as desired, or, as shown in the illustrated embodiment, the data stored by the monitor may be wirelessly downloaded via the wireless transceiver 104′ as will be appreciated by those skilled in the art. The data may be exceedance data or just periodically sampled data, for example.

In the embodiments where it is desired to keep the sterilized food product at a temperature lower than ambient, a refrigeration unit 105′ may be coupled to the rigid shell 71′. The refrigeration unit 105′ may be carried by one of the support frame assemblies or by the rigid shell 71′.

With particular reference to FIG. 5, the rigid shell 71′ may comprise a stainless steel layer 106′. In addition, an insulating layer 108′ may surround the stainless steel layer 106′. The rigid shell 71′ also illustratively includes a gas port 90′ for permitting a flow of sterile gas to maintain a positive pressure within the rigid shell 71′, such as during transporting and/or emptying. The gas port 90′ may alternatively be positioned in the forward or front closed end 75b′ in other embodiments.

The rigid shell 71′ further has a sterilized food product filling port 91′ therein, and a manway port 92′ therein. The gas port 90′ may include a suitable fitting coupled thereto, not shown, for external connection. The food product filling port 91′ may also include a suitable fitment, not shown, coupled to the port. And the manway port 92′ may have a suitable manway hatch, not shown, associated therewith. Other configurations of ports are also possible as will be appreciated by those skilled in the art.

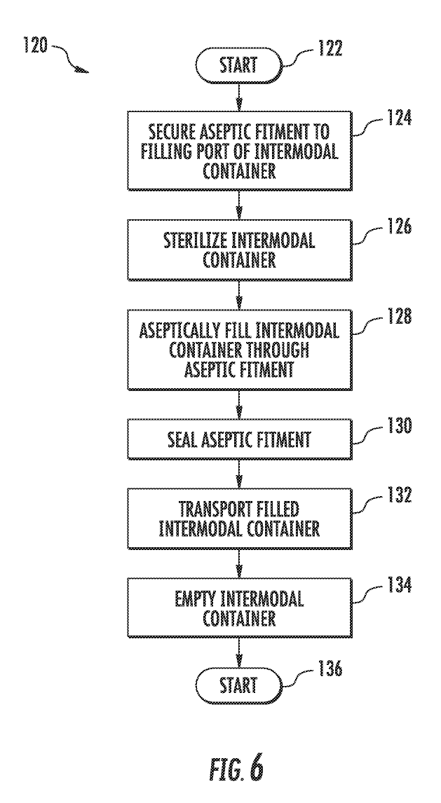

Another aspect relates to a method for aseptically filling the intermodal container 70′. Referring to the flowchart 120 of FIG. 6, the filling method is now described. After the start (Block 122), the method includes securing an aseptic fitment to the filling port of the intermodal container (Block 124). The aseptic fitment is not a conventional aseptic valve as will be appreciated by those skilled in the art.

The intermodal container 70′ may be of the type described above, although the placement of the discharge port in a medial portion of the rear closed end is not necessary to these embodiments directed to filling. Of course, the discharge port placement, conically shaped closed end, and aseptic fitment as now described may be advantageously used in combinations or all together in some embodiments.

The method also includes sterilizing the intermodal container (Block 126) and aseptically filling the sterilized intermodal container with the sterilized food product through the aseptic fitment at Block 128. At Block 130 the method also includes sealing the aseptic fitment after aseptic filling. The filled intermodal container 70′ may be transported (Block 132) before emptying (Block 134) and before stopping at Block 136.

As already explained, after aseptic filling the method may also include maintaining at least one of a desired pressure and desired temperature within the intermodal container during transporting. The method may include recording at least one of the desired pressure and desired temperature, and wirelessly transmitting the data. The sterilizing may be performed using at least one of steam and a chemical sterilant. Accordingly, the method permits large bulk quantities of sterilized food product to be aseptically transported, and without additional sterilization and/or pasteurization steps.

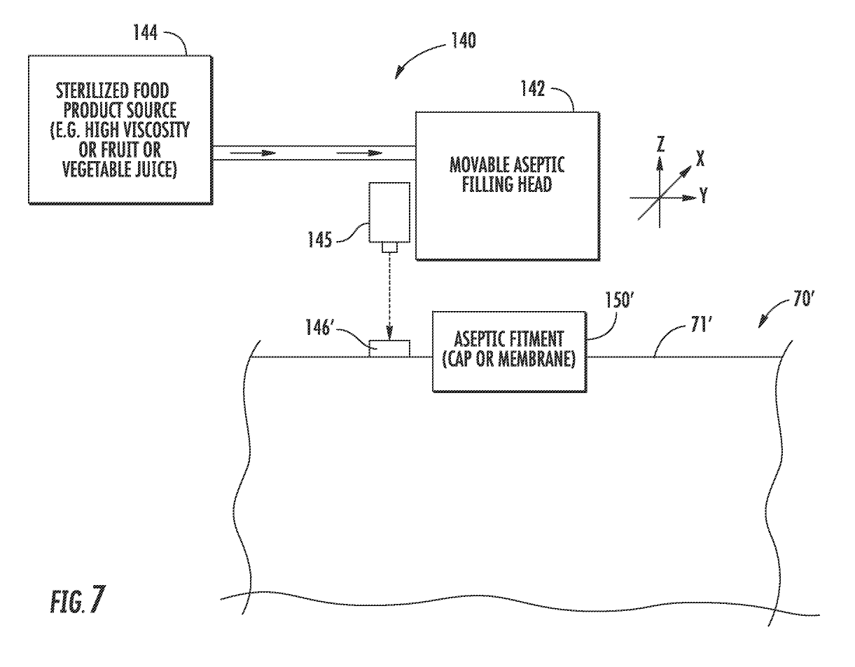

Turning now additionally to FIG. 7 further features of the aseptic filling method, the intermodal container 70′ and the associated filling station 140 are now described. The aseptically filling is illustratively carried out using a moveable aseptic filling head 142 that is part of an aseptic filling station 140 that also includes a sterilized food source 144 coupled to the moveable filling head. A typical aseptic filling station for the flexible bag containers as described in the background above relies upon an operator to manually attach the bag to the filler head. Such a bag filler is unsuitable for the intermodal container and associated methods. Accordingly, the filling station 140 in accordance with this aspect includes a moveable filling head 142 that is moveable in at least an x-y plane. Movement in the z-direction is also advantageously provided. A frame, not shown, may mount the moveable aseptic filling head 142 and various associated positioning actuators, not shown, as will be appreciated by those skilled the art.

Of course, the relatively large intermodal container 70′ will typically be maintained in a fixed position during aseptic filling, such as when positioned on the bed of a truck. Accordingly, filling comprises aligning the moveable aseptic filling head 142 relative to the intermodal container 70′, since the intermodal container is stationary.

To facilitate aligning the moveable aseptic filling head 142 relative to the rigid shell 70′ and the aseptic fitment 150′, the filling head may have coupled thereto at least one sensor 145. The sensor 145 may operate based upon at least one of optical, mechanical and electrical sensing. For example, the sensor 145 may be a camera. Of course other configurations and types of sensors may be used. In addition, the intermodal container 70′ may include at least one alignment feature 146′ adjacent the aseptic fitment 150′. For example, the alignment feature 146′ may comprise an optically viewable pattern of indicia, mechanically sensed ridges or patterns, or capacitive or inductive components for electrical sensing as will be appreciate by those skilled in the art. In some embodiments, no alignment feature may be needed on the rigid shell 70′, such as for optical sensing using a camera, for example.

The truck carrying the intermodal container 70′ may be positioned within a range of possible motion of the moveable filler head 142, and, thereafter, the moveable filler head 142 may guide itself into precise engagement with the aseptic fitment 150′, or may be guided with the assistance of an operator. Of course in other embodiments, a transport vehicle other than a truck may be used to carry the intermodal container 70′ as will be appreciated by those skilled in the art.

In some embodiments, the aseptic fitment 150′ comprises a membrane-type aseptic fitment, and the moveable aseptic filling head 142 is compatible with the membrane-type aseptic fitment. In other embodiments, the aseptic fitment 150′ comprises a cap-type aseptic fitment, and the moveable aseptic filling head 142 is compatible with the cap-type aseptic fitment. The method may further comprise supplying a sterile gas to maintain a positive pressure within the intermodal container 70′ during aseptic filling. The sterile gas may be introduced through the gas port 90′ (FIG. 5).

The sterilized food source 144 may contain a viscous sterilized food product having an absolute viscosity of greater than 500 centipoise, such as sterilized citrus pulp. In other embodiments, the sterilized food product may comprise sterilized fruit or vegetable juice, or other fluid food product as will be appreciated by those skilled in the art.

Other aspects and features of the intermodal container 70′ have already been described with respect to transporting and emptying, and these same features are also advantageous for aseptically filling and transporting. For example, the optional refrigeration, insulation, and data logging may also be used after aseptic filling through the aseptic fitment 150′ as will be appreciated by those skilled in the art.

The conventional filling approaches typically require the re-sterilization of the feed pipe and hoses during every filling cycle. These approaches are time consuming and susceptible to possible contamination.

An aseptic filling head for the bag containers is known in the art. For example, U.S. Pat. Nos. 4,445,550 and 4,805,378 each discloses such an aseptic filling head and each is incorporated herein by reference in its entirety.

An aseptic fitment with a frangible membrane (rupture disk) is described in U.S. Pat. No. 4,494,363, incorporated herein by reference in its entirety, and assigned to FranRica Mfg. Inc. This type of fitment is currently made by companies such as Scholle Corporation of North Lake, Ill. under the model designations 1700 and 5100. An aseptic fitment with a plastic cap is disclosed in U.S. Pat. Nos. 4,355,742 and 4,120,134 each incorporated herein by reference in its entirety. Scholle Corporation also makes the cap-type fitments under the model designations 800X, 800L and 2600. Other prior art packaging material and filling apparatus are disclosed U.S. Pat. Nos. 3,514,919; 2,930,170; 3,340,671; 3,356,510; 3,427,646; 4,137,930; and 4,201,208 each incorporated herein by reference in its entirety.

Bag-in-box (300 gallon) containers and other packaging materials as disclosed above are currently being filled with aseptic filling heads. However, these are flexible bag containers with limited capacity and that are also not pressurized. In these systems, the filling head is fixed in the x-y plane and the fitment of the flexible container is moved to mate with the filling head. Over the road tankers and intermodal containers are currently being filled through a common filling/discharge valve. Unfortunately, sterilization of the valve and filling hose is required between each tanker. The methods, intermodal containers and filling station described herein overcome these and other deficiencies of the prior art approaches.

For a membrane-type fitment, during filling the moveable aseptic filling head 142 is aligned and sealed against the aseptic filling fitment 150′. The external surfaces of the aseptic fitment and filling head are then sterilized by steam or chemical sterilant. The rupture membrane is broken by the filling head and sterile food product is introduced into the intermodal container 70′. A sterile cap is sealed over the fitment while still under sterile conditions, and the aseptic filling head 142 is removed from the aseptic fitment 150′. For a cap-type fitment the cap is first removed, then replaced after filling.

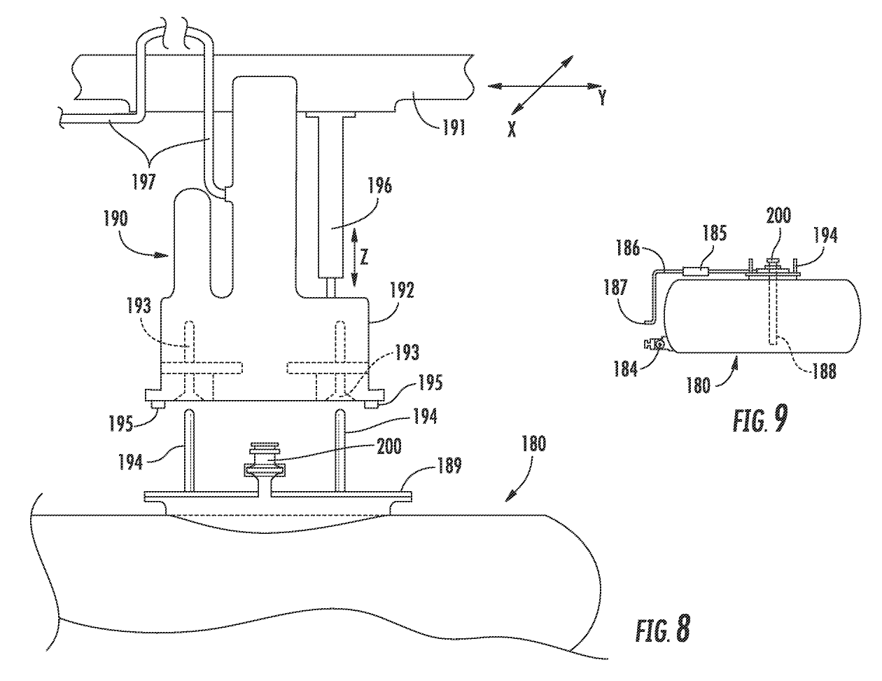

Further aspects of the embodiments described herein are now described with additional reference to FIGS. 8 and 9. The intermodal container 180 is fitted with a manway cover 189 that includes various fittings. These fittings include a membrane-type aseptic fitment 200 and a pair of alignment rods 194 for aligning with the aseptic filling head 190. Other fittings, not shown, may include fittings for cleaning, tank access and the introduction of sterile gas as will be appreciated by those skilled in the art.

The aseptic filling head 190 includes a movable frame 191 that allows the aseptic filling chamber 192 to move in the x-y plane to align with the aseptic fitment 200. The aseptic filling chamber 192 includes alignment features in the form of alignment rod receiving recesses 193 cooperating with the alignment rods 194 for aligning the filling head 190 with respect to the manway cover 189, and, hence, with respect to the aseptic fitment 200. Contact and/or proximity sensors 195 are also provided for sensing when the filling chamber 192 is in the correct upright position relative to the intermodal container 180. The filling chamber 192 may be one of many types available in the industry, such as those made by JBT Corporation or Scholle Corporation. The aseptic filling head 190 also illustratively includes an actuator 196 for upright movement (i.e. along the z-axis) and a flexible hose 197 for the transport of the food product.

Other parts of the intermodal container 180 include a product discharge valve 184, and a gas line 186 having an inlet 187 for introducing sterile gas into the container through a sterile gas filter cartridge 185 as shown in FIG. 9. An upright filling tube 188 is connected to fill port of the intermodal container 180. This optional filling tube 188 allows for the filling of certain liquids into the bottom of the intermodal container 180 to minimize or reduce splashing or foaming during the filling operation.

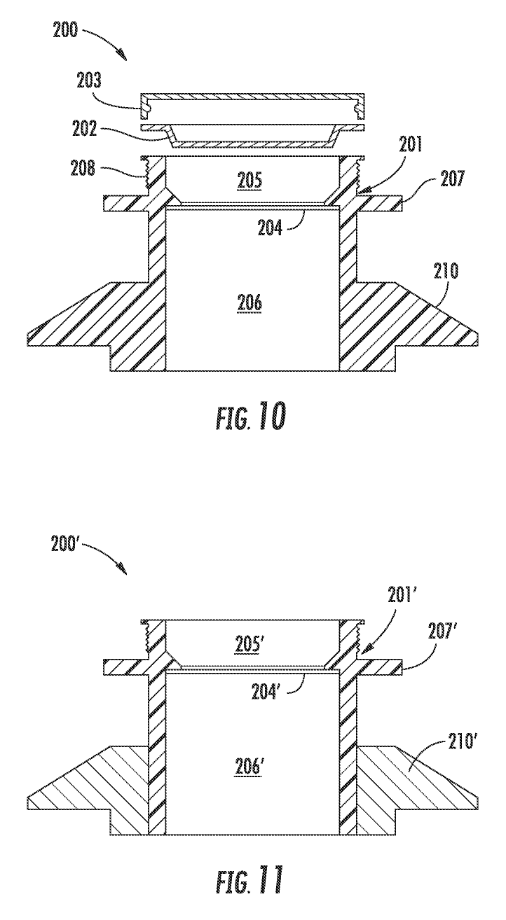

Referring now additionally to FIGS. 10-14 the membrane-style aseptic filling fitment 200 is further described. The fitment 200 includes an aseptic fitment body 201, a sealing disc 202, and a screw cap 203. The fitment body 201 is preferably molded of a suitable plastic material, such as high-density polyethylene. The fitment body 201 receives a frangible membrane or diaphragm 204 to extend across the filling opening 205. The membrane 204 is sufficiently strong to withstand a pressure of 15-30 psi, for example, to which the membrane may be exposed during sterilization of the lower neck opening 206 when mounted on the intermodal container 180.

The fitment body 201 also includes a clamping flange 207 to accommodate the clamping jaws of the filling head 190, a threaded neck 208 adapted to receive the screw cap 203, and a beveled clamping shoulder 210 for clamping onto a receiving tank ferrule 211 (FIG. 13). The beveled clamping shoulder 210 is, for example, of a style known as an I-line fitting. Other aseptic connections such as DIN 11864-2 aseptic flange unions or DIN 11-864-1 aseptic screwed unions could also be used to mount the filling fitment 200 onto the intermodal container.

An alternative embodiment of the membrane-type aseptic fitment 200′ is shown in FIG. 11 and includes a fitment body 201′ molded of a suitable plastic material and a separate beveled clamping shoulder 210′ preferably made of stainless steel. The two parts are bonded together through either melting of the molded plastic fitment body 201′ or through the use of a suitable bonding agent.

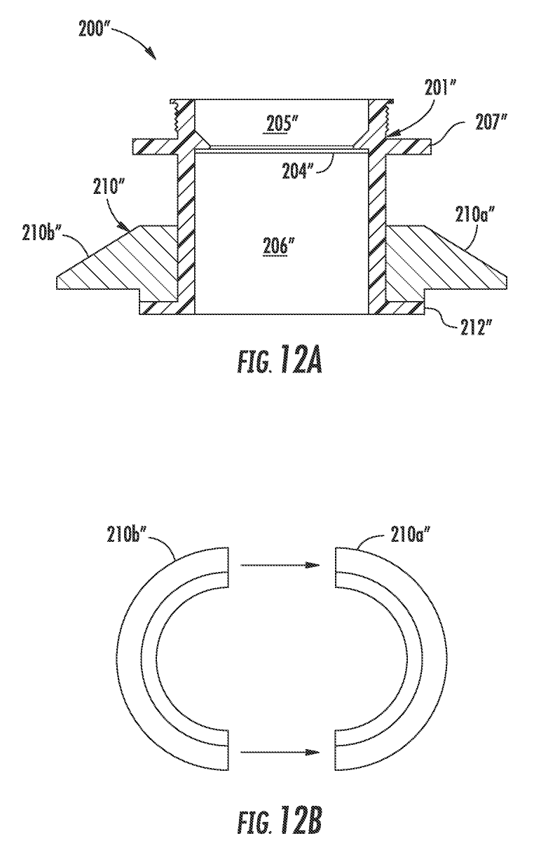

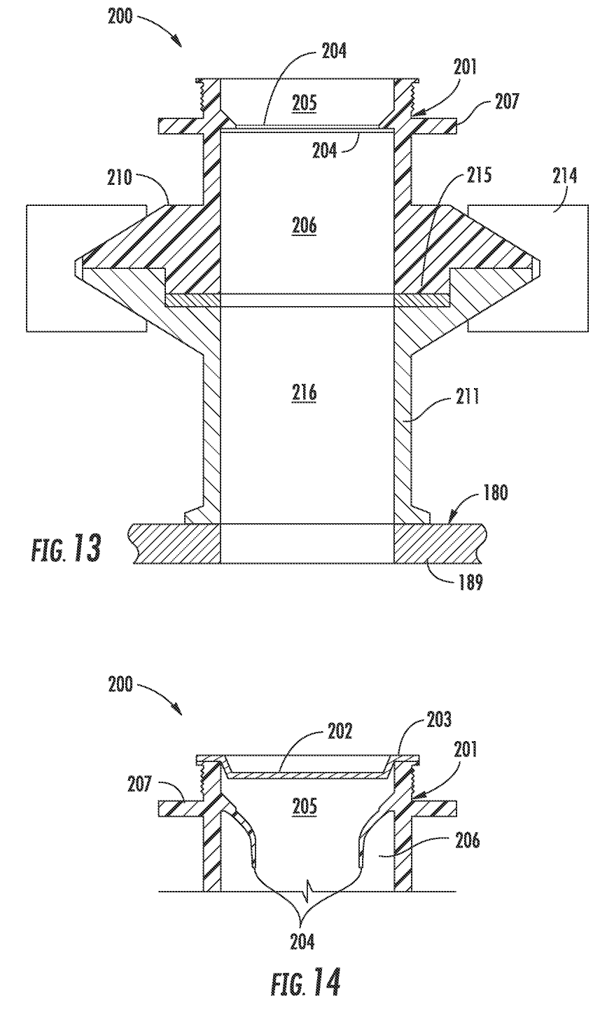

Another alternative embodiment of the membrane-type aseptic fitment 200″ is now described with specific reference to FIGS. 12A and 12B. In this embodiment, the filling fitment 200″ includes a filling fitment body 201″ molded of a suitable plastic material and a separate, two-piece beveled clamping shoulder 210″ preferably of stainless steel. The two-part clamping shoulder 210″ comprises a left-hand shoulder portion 210a″ and a right-hand shoulder portion 210b″ which are assembled onto the fitment body 201″ during assembly onto the intermodal container 180. The fitment body 201″ also includes a lower shoulder 212″ for sealing against a gasket 215 (FIG. 13) during assembly onto the intermodal container 180.

The membrane-type aseptic fitment 200 as assembled onto the intermodal container 180 is further described with more specific reference to FIG. 13. The receiving ferrule 211 is preferably a stainless steel ferrule, such as a female I-line ferrule welded onto the manway cover 189. A gasket 215 of suitable material, such as Viton rubber, is located between the fitment body 201 and the mating ferrule 211 and is sealed in place through the use of a clamp 214, such as an I-line clamp. The internal space 216 within the neck of the receiving ferrule 211, the gasket 215 and the lower filling opening 206 of the fitment body 201 can all be sterilized along with the internal portion of the intermodal container 180 by steam or chemical sterilization as will be appreciated by those skilled in the art. The upper fill opening 205 of the fitment 200 along with the top surface of the membrane 205 are sterilized by the aseptic filling head 190 prior to rupturing of the membrane 204 during filling.

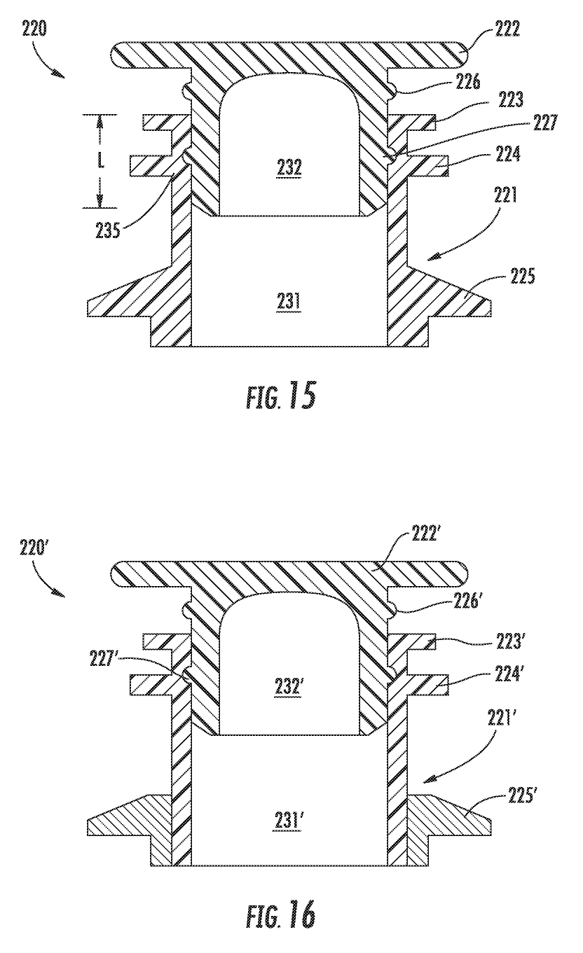

As best shown in FIG. 14, after the completion of the filling operation, the membrane 204 has been ruptured, and the sealing disc 202 has been sealed onto the fitment body 201 and secured by the cap 203. The sealing disc 202 is preferably formed of a multilayer material including a layer of low density polyethylene and a layer of aluminum foil which are adhesively bonded together. After filling, the disc 202 is sealed to the fitment body 201 by heat, for example.

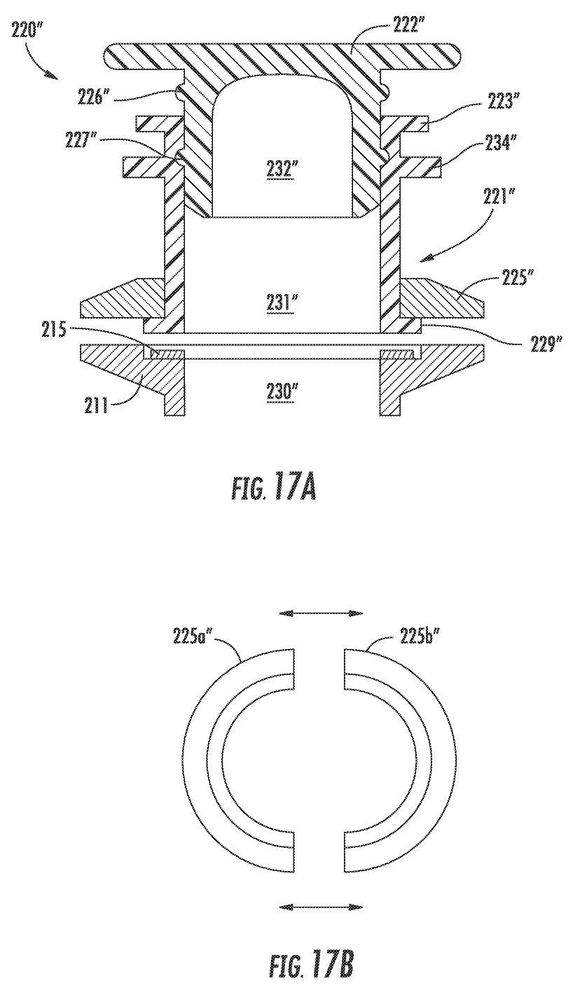

Turning now to FIGS. 15-18, a cap-style aseptic fitment 220 for use on the intermodal container 180 is now described. The aseptic fitment 220 includes a fitment body 221, and a sealing cap 222. The fitment body 221 is preferably molded of a suitable plastic material, such as high-density polyethylene. The fitment body 221 includes an upper clamping flange 223 and a lower clamping flange 224 to accommodate the clamping jaws of the filling head, and a beveled clamping shoulder 225 for clamping onto a receiving tank ferrule 211. The beveled clamping shoulder 225 is, for example, of a style known as an I-line fitting. The sealing cap 222 includes an upper contact ring 226 and a lower contact ring 227 for sealing with the fitment body 221. Prior to filling as shown in FIG. 15, for example, the cap 222 has been partially pushed into the fitment body 221 so that the lower contact ring 227 is in sealing contact with a corresponding recess in the fitment body.

An alternative embodiment of the cap-type aseptic fitment 220′ is shown in FIG. 16. In this embodiment, the filling fitment 220′ includes the filling fitment body 221′ molded of a suitable plastic material, and a separate beveled clamping shoulder 225′ at the base of the body and preferably made of stainless steel, for example. The two parts 221′, 225′ are bonded together through either melting of the molded plastic fitment body 221′ or through the use of a suitable bonding agent.

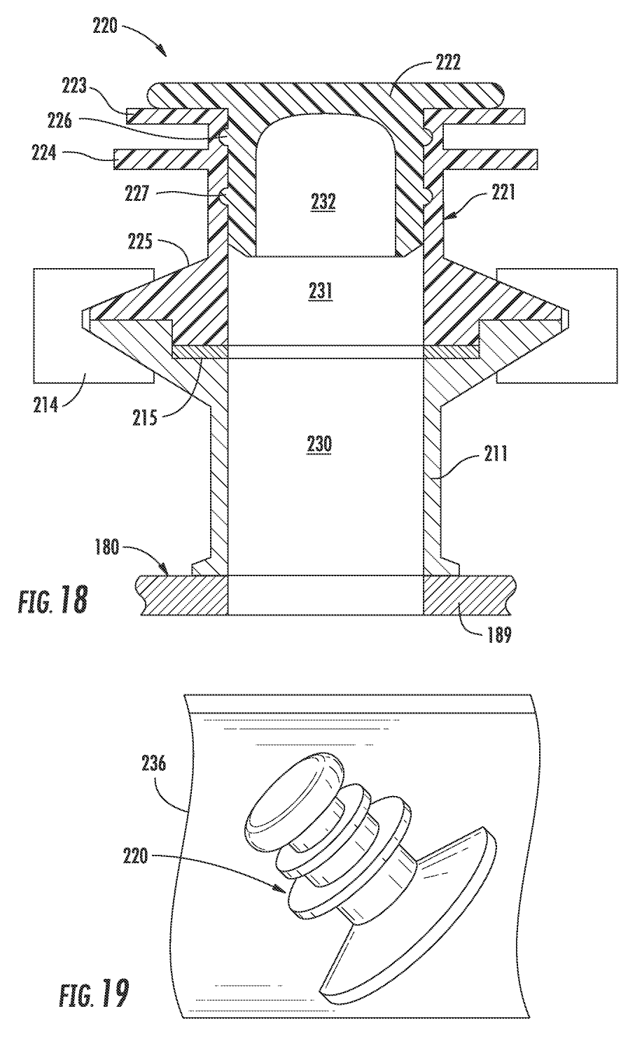

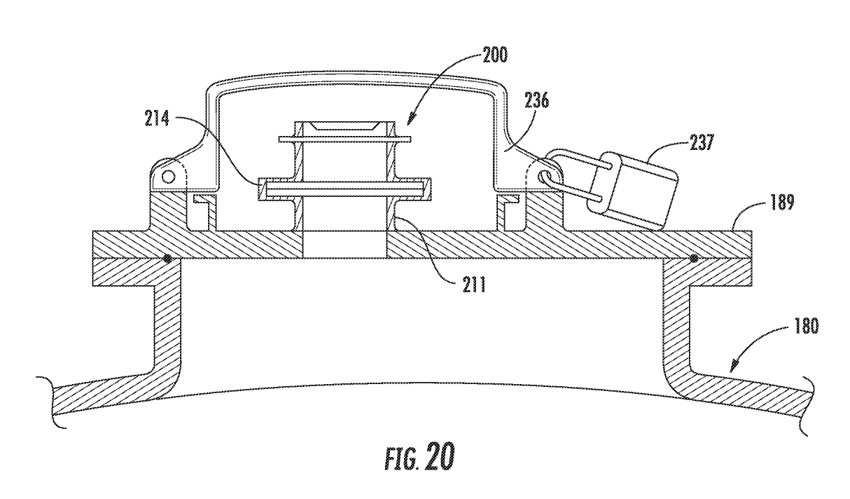

Another alternative embodiment of the cap-type aseptic filling fitment 220″ is shown in FIGS. 17A and 17B. The fitment 220″ in this embodiment includes the filling fitment body 221″ molded of a suitable plastic material and a separate, two-piece beveled clamping shoulder 225″ preferably of stainless steel. The two-part clamping shoulder 225″ includes a left-hand shoulder portion 225a″ and a right-hand shoulder portion 225b″ which are assembled onto the fitment body 221″ during assembly onto the intermodal container 180. The fitment body 221″ also includes a lower shoulder 229″ for sealing against a gasket 215 during assembly onto the container 180 (FIG. 18).

The cap-type aseptic fitment 220 is assembled onto the intermodal container 180 at a receiving ferrule 211 that is connected to the manway cover 189 of the intermodal container 180 as shown in FIG. 18. The receiving ferrule 211 may preferably be a stainless steel ferrule, such as a female I-line ferrule welded onto the manway cover 189. A gasket 215 of suitable material, such as Viton rubber, is located between the lower end of the fitment body 221 and the mating receiving ferrule 211, and is sealed in place through the use of a clamp 214, such as an I-line clamp. As will be appreciated by those skilled in the art, the internal neck area 230 of the receiving ferrule 211, the gasket 215, the lower filling opening 231 of the fitment body 221, and the internal cap cavity 232 can be sterilized along with the internal part of the intermodal container 180 by steam or chemical sterilization. The outer surface of the cap 222 is sterilized by the aseptic filling head prior to removing the cap during filling.

The only surface of the cap-style filling fitment 220 that is not sterilized during the container sterilization process or the aseptic filling process is the contact surface 235 (FIG. 15) of the initial overlap region extending along the length L between the cap 222 and the filling fitment body 221. In order to properly sterilize this surface 235, the filling fitment 220 may be sealed in a sealable package 236 (FIG. 19) of suitable material and exposed to gamma radiation. The entire cap-type aseptic filling fitment 220 is then kept clean and sterile until it is ready to be assembled onto the intermodal container 180.

After filling and sealing either of the aseptic fitments 200, 220 a hinged protective cover 236 may be positioned over the fitment to protect the fitment during transportation, as shown in FIG. 20. The hinged cover 236 may be lockable to the container via the illustrated lock 237 or may be sealed with a tamper resistant seal to avoid tampering during transportation.

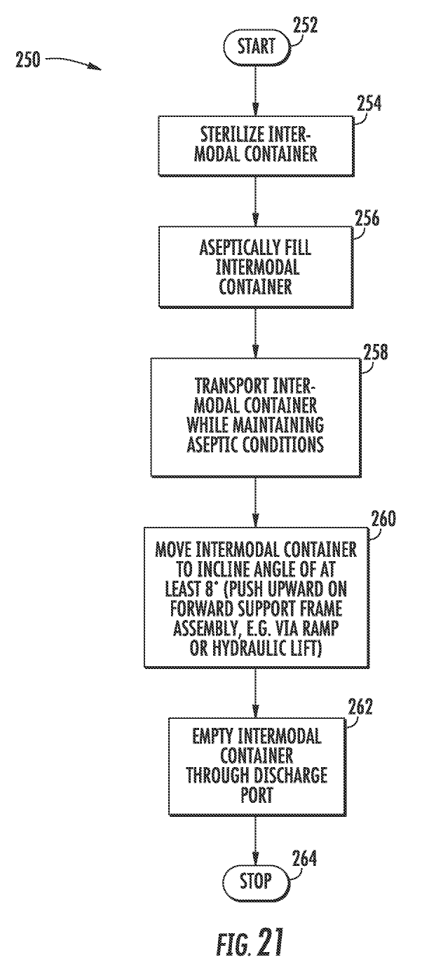

Referring now to the flowchart 250 of FIG. 21, another method for handling a sterilized food product is now described. After the start (Block 252), the method includes sterilizing an intermodal container (Block 254), such as, for example, the intermodal container comprising a rigid shell having an elongate shape with forward and rearward closed ends and a discharge port in the rearward closed end. The intermodal container may also include forward and rearward support frame assemblies supporting the rigid shell. In other words, the intermodal container may be of the type described herein. The sterilizing may comprise sterilizing the interior of the intermodal container using at least one of steam and a chemical sterilant. Other configurations of intermodal containers may also be used as will be appreciated by those skilled in the art.

The method also includes aseptically filling the intermodal container with the sterilized food product at Block 256. At Block 258 the method also includes transporting the filled intermodal container via a transport vehicle, such as at least one of rail, truck, and ship, while maintaining the sterilized food product in aseptic conditions.

At the desired emptying destination or site, the method includes at Block 260 moving the intermodal container to an incline angle of at least 8 degrees from horizontal. For example, this may be achieved in some embodiments by pushing upwardly on the forward support frame assembly to rotate the intermodal container to an incline angle of at least 8 degrees from horizontal. Of course, in other embodiments, other approaches may be used to rotate or move the intermodal container to an incline angle of at least 8 degrees from horizontal, such as engaging the intermodal container and/or its support frame assembly with a lifting device. The method further includes emptying the sterilized food product from the discharge port (Block 262) before stopping at Block 264.

In some embodiments, a pump may be used in addition to gravity. Also, the method may include supplying a sterile gas to maintain a positive pressure, for example, of 5 to 20 psi within the intermodal container at least during emptying to provide additional pressure to assist emptying. Attempting to solely pump such a viscous food product from an intermodal container in the horizontal orientation may take a relatively long time and/or leave an undesirably large amount of food product within the container as will be appreciated by those skilled in the art.

The method advantageously permits a bulk quantity of sterilized food product to be efficiently transported and emptied from the intermodal container using the advantage of gravity-based or gravity-assisted emptying. The method is particularly advantageous for such emptying when the sterilized food product comprises a viscous sterilized food product, such as citrus pulp, for example, or other food product having an absolute viscosity of greater than 500 centipoise. The emptying may also be carried out aseptically as will be appreciated by those skilled in the art.

The method may include maintaining at least one of a desired pressure and desired temperature within the intermodal container during transporting. Also, the method may comprise at least one of recording and wirelessly transmitting at least one of the desired pressure and desired temperature.

The incline angle may be at least 18 degrees from horizontal in some embodiments, and at least 30 degrees from horizontal in other embodiments. It has been determined that at an angle of 8 degrees, about 1.6% of the sterilized food product in the form of citrus pulp remains in the intermodal container, while a pressure of 15 psi is maintained in the intermodal container. At an angle of 18 degrees, about 0.5% of the sterilized food product (citrus pulp) remains in the intermodal container at the same pressure. Either of these angles may be acceptable depending on the particular requirements of the user as will be appreciated by those skilled in the art. In other embodiments, an angle of at least 30 degrees may also be used and is readily obtained.

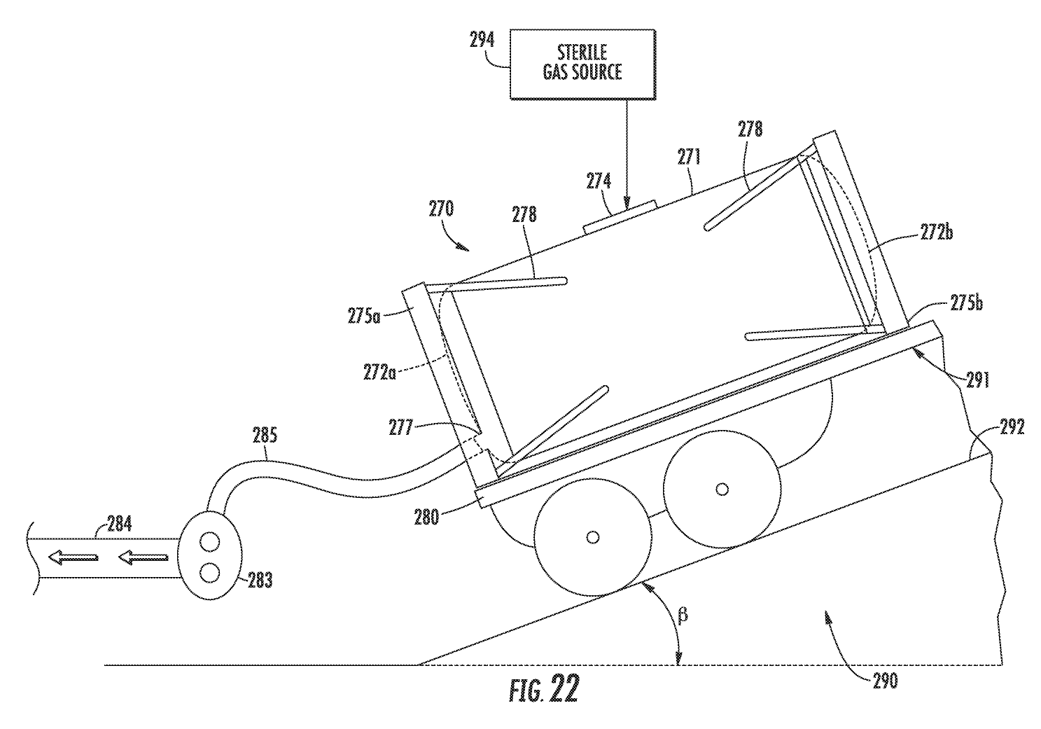

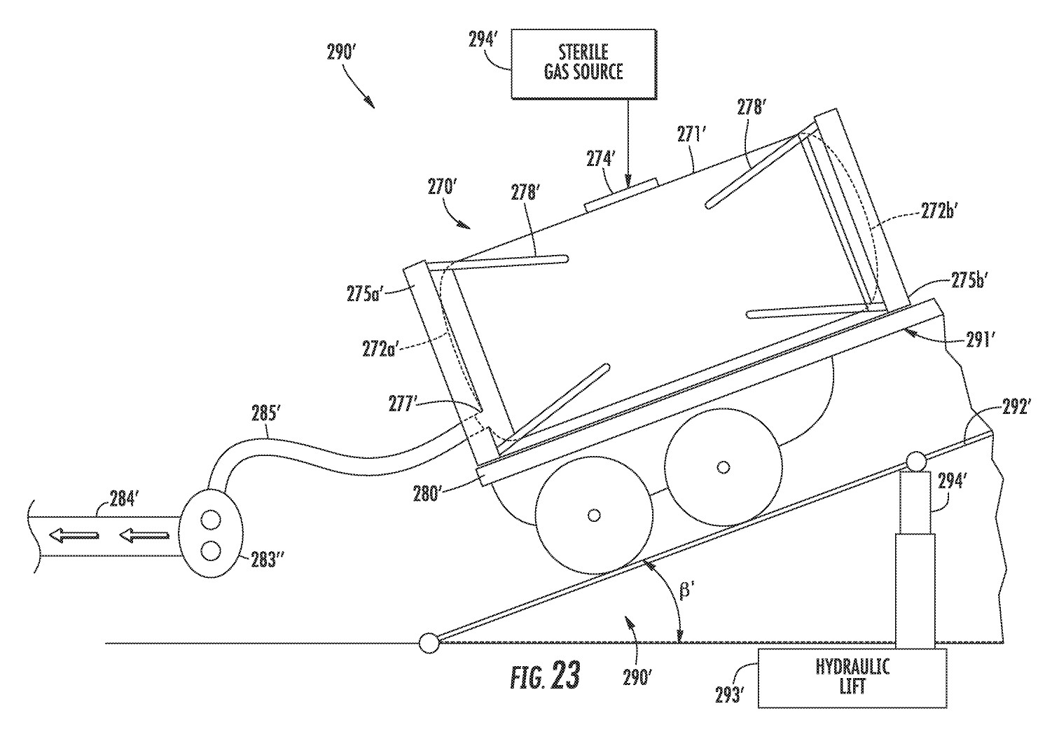

With additional reference to FIG. 22 one embodiment of a system 290 for pushing upwardly on the forward support assembly 275b to rotate and empty the intermodal container 270 is further described. In this embodiment, the transport vehicle in the form of the truck 291, including a truck bed 280 carrying the intermodal container 270, is rotated by advancing the truck up an inclined ramp 292. The ramp 292 has an incline angle of β of at least 8 degrees, or at least 18 degrees in other embodiments, or at least 30 degrees in yet other embodiments.

The intermodal container 270 may have a capacity greater than 10,000 liters, and has the discharge port 277 in a lower portion of the rearward closed end 272a of the intermodal container that is opposite the forward closed end 272b. The intermodal container 270 also has the forward support frame assembly 275b and a rearward support frame assembly 275a. The intermodal container 270 also illustratively includes a rigid shell 271 and a plurality of corner support struts 278 extending from the respective support frame assemblies 275a, 275b to corresponding attachment areas along the outside of the rigid shell. A manway 274 may also be provided for access to the interior of the shell 271.

During emptying a sterile gas may be supplied from the sterile gas source 294 to the interior of the rigid shell 271. A first outlet hose 285 is also illustratively coupled between the discharge port 277 and the pump 283. The sterile food product is then urged by the pump 283 through the second outlet hose 284 coupled thereto.

Now referring to FIG. 23 another embodiment of a system 290′ for emptying is further described. In this embodiment, the transport vehicle in the form of the truck 291′, including the truck bed 280′ carrying the intermodal container 270′, pushes upwardly on the forward support frame assembly 272b′ by advancing the truck onto a hydraulically raised platform 292′. A hydraulic lift 293′ advances one or more telescoping pistons 294′ to rotate the platform 292′ and, therefore, the truck 291′ and attached intermodal container 270′ to an incline angle of β of at least 8 degrees, or at least 18 degrees, or at least 30 degrees, as described above. In other words, in this embodiment a lift is used to raise the front of the truck 291′ relative to the back of the truck to thereby push the forward support frame 272b′ and rotate the intermodal container 270′. Those other elements of the system 290′ not specifically described are the same as those described above with reference to FIG. 22.

In addition, other features relating to the area of aseptically handling food products are disclosed in the copending patent application assigned to the assignee of the present invention and is entitled METHOD AND APPARATUS FOR ASEPTIC FILLING OF FOOD PRODUCT, Ser. No. 12/941,155, filed on Nov. 8, 2010, the entire disclosure of which is incorporated herein in its entirety by reference. Many modifications and other embodiments of the invention will come to the mind of one skilled in the art having the benefit of the teachings presented in the foregoing descriptions and the associated drawings. For example, the methods and structures disclosed herein for intermodal containers could also be applied to over-the-road tankers, and/or railcars as will be appreciated by those skilled in the art. Therefore, it is understood that the invention is not to be limited to the specific embodiments disclosed, and that modifications and embodiments are intended to be included within the scope of the appended claims.

That which is claimed is:

1. A method for handling a sterilized food product comprising:
sterilizing an intermodal container comprising a rigid shell with opposed closed ends and a discharge port in one of the closed ends;
aseptically filling the intermodal container with the sterilized food product;
transporting the filled intermodal container while maintaining the sterilized food product in aseptic conditions; and
at an emptying site, moving the intermodal container to an incline angle of at least 8 degrees from horizontal, and emptying the sterilized food product from the discharge port.

2. The method according to claim 1 wherein the rigid shell has an elongate shape.

3. The method according to claim 2 wherein the intermodal container comprises forward and rearward support frame assemblies supporting the rigid shell.

4. The method according to claim 3 wherein the opposing closed ends comprise forward and rearward closed ends and the discharge port is in the rearward closed end.

5. The method according to claim 4 wherein transporting comprises transporting the filled intermodal container via a transport vehicle.

6. The method according to claim 5 wherein moving the intermodal container comprises pushing upwardly on the forward support frame assembly to rotate the intermodal container.

7. The method according to claim 6 wherein pushing upwardly comprises advancing the transport vehicle up an inclined ramp.

8. The method according to claim 6 wherein pushing upwardly comprises raising a front of the transport vehicle relative to a back of the transport vehicle.

9. The method according to claim 1 further comprising supplying a sterile gas to maintain a positive pressure within the intermodal container at least during emptying.

10. The method according to claim 1 further comprising using a pump coupled to the discharge port during emptying.

11. The method according to claim 1 wherein the incline angle is at least 18 degrees from horizontal.

12. The method according to claim 1 wherein the incline angle is at least 30 degrees from horizontal.

13. The method according to claim 1 wherein the sterilized food product comprises a viscous sterilized food product having an absolute viscosity of greater than 500 centipoise.

14. The method according to claim 1 wherein the sterilized food product comprises sterilized citrus pulp.

15. The method according to claim 1 wherein the intermodal container has a capacity greater than 10,000 liters.

16. The method according to claim 1 wherein the discharge port is in a lower portion of the rearward closed end of the rigid shell.

17. The method according to claim 1 wherein sterilizing comprises sterilizing using at least one of steam and a chemical sterilant.

18. A method for handling a sterilized food product comprising:
transporting an intermodal container filled with the sterilized food product while maintaining the sterilized food product in aseptic conditions, the intermodal container comprising a rigid shell having opposing closed ends and a discharge port in one of the closed ends; and
at an emptying site, moving the intermodal container to an incline angle of at least 8 degrees from horizontal, and emptying the sterilized food product from the discharge port.

19. The method according to claim 18 wherein the rigid shell has an elongate shape.

20. The method according to claim 19 wherein the intermodal container comprises forward and rearward support frame assemblies supporting the rigid shell.

21. The method according to claim 20 wherein the opposing closed ends comprise forward and rearward closed ends and the discharge port is in the rearward closed end.

22. The method according to claim 21 wherein transporting comprises transporting the filled intermodal container via a transport vehicle.

23. The method according to claim 22 wherein moving the intermodal container comprises pushing upwardly on the forward support frame assembly to rotate the intermodal container.

24. The method according to claim 23 wherein pushing upwardly comprises advancing the transport vehicle up an inclined ramp.

25. The method according to claim 23 wherein pushing upwardly comprises raising a front of the transport vehicle relative to a back of the transport vehicle.

26. The method according to claim 18 further comprising supplying a sterile gas to maintain a positive pressure within the intermodal container at least during emptying.

27. The method according to claim 18 further comprising using a pump coupled to the discharge port during emptying.

28. The method according to claim 18 wherein the incline angle is at least 18 degrees from horizontal.

29. The method according to claim 18 wherein the incline angle is at least 30 degrees from horizontal.

30. The method according to claim 18 wherein the sterilized food product comprises a viscous sterilized food product having an absolute viscosity of greater than 500 centipoise.

31. The method according to claim 18 wherein the sterilized food product comprises sterilized citrus pulp.
